(19) United States
(12) Patent Application Publication
(10) Pub. No.: US 2024/0068258 A1
(43) Pub. Date: Feb. 29, 2024

(54) AUTOMATIC SWIMMING POOL CLEANER WITH WATER SENSING

(71) Applicant: ZODIAC POOL CARE EUROPE, Belberaud (FR)

(72) Inventors: Arnaud Besnier, Beaupuy (FR); Louis Favié, Colomiers (FR); Quentin Lutrand, Belberaud (FR)

(73) Assignee: ZODIAC POOL CARE EUROPE, Belberaud (FR)

(21) Appl. No.: 18/236,722

(22) Filed: Aug. 22, 2023

Related U.S. Application Data
(60) Provisional application No. 63/401,428, filed on Aug. 26, 2022.

(51) Int. Cl. E04H 4/16

(52) U.S. Cl. CPC E04H 4/1654

(57) ABSTRACT

A water sensing system for an automatic swimming pool cleaner (APC) may include one or more water sensing probes on or proximate to the APC. In some embodiments, the at least one water sensing probe may be inside the APC, outside the APC, and/or proximate to but spaced apart from the APC, such as but not limited to on cabling of the APC.

### REFERENCE TO RELATED APPLICATION

This application claims the benefit of U.S. Provisional Patent Application No. 63/401,428, filed on Aug. 26, 2022, and entitled AUTOMATIC SWIMMING POOL CLEANER WITH WATER SENSING, the content of which is hereby incorporated by reference in its entirety.

### FIELD OF THE INVENTION

The invention relates to systems and apparatuses for cleaning water-containing vessels such as swimming pools and spas and more particularly, although not necessarily exclusively, to automatic swimming pool cleaners (APCs).

### BACKGROUND OF THE INVENTION

Numerous cleaning devices capable of autonomous movement within swimming pools and spas currently exist. The most common of these devices are APCs, which often are either hydraulic or robotic in type. Hydraulic cleaners vary water flow for movement, while robotic cleaners typically employ electric motors to cause motion. Hydraulic APCs, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, an APC for a swimming pool or spa includes an associated water sensing means.

According to various embodiments, an APC for a swimming pool or spa includes a water sensing system.

According to certain embodiments, a method of managing water of a swimming pool or spa includes managing the water based on information from a water sensing system on or proximate to an APC.

According to some embodiments, an APC for a swimming pool or spa includes an onboard water sensing system.

According to various embodiments, an APC for a swimming pool or spa includes a water sensing probe proximate to a body of the APC.

According to certain embodiments, a water sensing system for an APC includes a water sensing probe configured to be on or proximate to the APC.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates an APC for a swimming pool or spa and with a water sensing system according to embodiments.

FIG. 2 illustrates a portion of the APC of FIG. 1 according to embodiments.

FIG. 3 illustrates the APC of FIG. 1 according to embodiments.

### DESCRIPTION OF THE INVENTION

Described herein are APCs for swimming pools or spas with water sensing systems on or proximate to the APC. In some embodiments, the water sensing systems described herein include one or more water sensing probes onboard the APC. In some embodiments, the water sensing system may be provided natively with an APC, while in other embodiments, the water sensing systems described herein may allow for an APC to be retrofit with a water sensing system.

Additionally, or alternatively, the water sensing systems described herein may include one or more water sensing probes proximate to the APC, such as but not limited to on cabling for the APC. Optionally, the water sensing probes may be detachable from the APC. APCs with water sensing systems described herein may be able to inform a user of the quality or characteristics of the water of the swimming pool or spa. In some embodiments, APCs and/or other equipment associated with the swimming pool may be controlled based on the information gathered by the water sensing systems associated with the APC. In this way, water of the swimming pool may be treated and/or otherwise managed using the APC or other equipment according to the information gathered by the water sensing systems. Various other benefits and advantages may be realized with the devices and methods provided herein, and the aforementioned advantages should not be considered limiting.

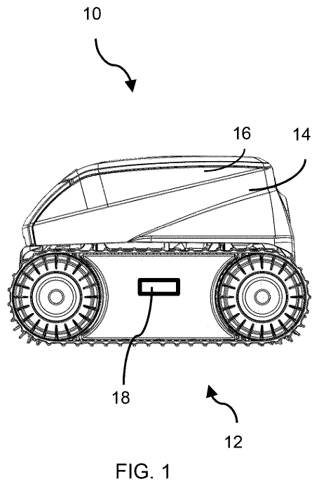

FIG. 1 illustrates an example of an APC 10 with a water sensing system 12 according to embodiments. The APC 10 generally includes a body 14 and one or more motive elements 16 (e.g., wheels, tracks, feet, etc.). A pump, filter assembly, cleaning device such as a brush assembly or other suitable device, any suitable electric or other motors, a controller (e.g., processor and memory), a communication module, an on-board power source (e.g., rechargeable batteries), and/or various other features may be provided on or within the APC 10 as desired. The APC 10 may be various types of APCs as desired, and the particular APC 10 illustrated should not be considered limiting. Other non-limiting examples of APCs 10 may include those described in U.S. Pat. Nos. 10,316,534, 9,488,154, 8,578,538, and U.S. Patent Publication No. 2014/0303810, all of which are hereby incorporated by reference in their entireties.

The water sensing system 12 may include one or more water sensing probes 18 provided on and/or proximate to the APC 10. The water sensing probe 18 may be various types of water sensors as desired, including but not limited to oxidation-reduction potential (ORP) sensors, pH sensors, temperature sensors, conductivity sensors, salinity sensors, other types of water sensors, and/or combinations thereof. In the embodiment illustrated in FIG. 1, the water sensing system 12 includes a water sensing probe 18 on the APC 10. However, the particular location of the water sensing probe 18 should not be considered limiting, and in other embodiments the water sensing probe 18 may be provided within the APC 10 (e.g., within a cavity defined by the body 14), on an outer surface of the APC 10, and/or proximate to the APC 10 (e.g., in line on cabling for the APC 10), among other locations. Moreover, the number of water sensing probes 18 should not be considered limiting, as in other embodiments, a plurality of waster sensing probes 18 may be utilized. In one non-limiting example, an APC 10 may include at least one ORP sensor, pH sensor, temperature sensor, conductivity sensor, and salinity sensor as a plurality of water sensing probes 18.

In various embodiments, the water sensing probes 18 optionally are communicatively coupled with the controller of the APC 10 via a wired or wireless connection. The controller of the APC 10 may use the information gathered by the water sensing probes 18 to control the APC 10 (e.g., adjust or initiate a cleaning cycle), and/or the controller of the APC 10 may cause the information from the water sensing system 12 to be communicated to an external device (e.g., a user device, smartphone, etc.) using the communication module of the APC 10. Such communication using the communication module may be wired communication and/or wireless communication (e.g., Bluetooth, WiFi, etc.).

Additionally, or alternatively, the water sensing system 12 may include a communication module itself such that the water sensing system 12 may communicate via wireless communication with an external device (e.g., a user device, smartphone, etc.). In such embodiments, data gathered by the one or more water sensing probes 18 may be transmitted to the external device and displayed on the external device using various techniques as desired. In some examples, the data gathered by the one or more water sensing probes may be displayed and/or provided to a user via an application on the external device. As mentioned, the water sensing system 12 and/or any components thereof may be provided natively with an APC, while in other embodiments, the water sensing systems 12 and/or components thereof may be retrofit with an existing APC.

In some embodiments, the water sensing probes 18 may be powered by the batteries or other on-board power source of the APC 10. However, in other embodiments, the water sensing probes 18 may be self-powered and/or may include a dedicated power source such as dedicated batteries.

The information from the water sensing system 12 may be used to perform various processes as desired. As non-limiting examples, the information from the water sensing system 12 may be communicated to a user, may be used to control the APC 10, and/or may be used to control equipment associated with the swimming pool or spa for treating and/or otherwise managing water quality of the swimming pool. As a non-limiting example, the information from the water sensing system 12 may be utilized by the controller of the APC 10 to control a cleaning operation and/or other operation of the APC 10, such as but not limited to controlling a cleaning cycle of the APC 10, controlling a location of cleaning by the APC 10, controlling a type of cleaning performed by the APC 10, causing the APC 10 to climb a wall, causing the APC 10 to dock with a docking station, cause the APC 10 to communicate with other equipment, and/or as otherwise desired. Additionally, or alternatively, the information from the water sensing system 12 may be utilized to control other equipment. As non-limiting examples, the information from the water sensing system 12 may be communicated to a user on an external device and/or to a control system for a pool environment, and based on the information, other equipment may be controlled. Such other equipment may include heaters, pumps, filtration systems, skimming systems, floor cleaning systems, pool lights, chemical treatment systems, combinations thereof, and/or as other equipment as desired. In various embodiments, the other equipment may be controlled to treat and/or manage water by performing various cleaning and/or water treatment operations, such as but not limited to increasing or decreasing a temperature using the heater, controlling a pumping speed of the pump, initiating, controlling, and/or ceasing skimming operations of the skimming system, initiating, controlling, and/or ceasing floor cleaning operations of the floor cleaning system, and/or as otherwise desired.

In yet other embodiments, a control response based on the information from the water sensing system 12 need not control other equipment. As a non-limiting example, an alert or other notification may be generated on the external device and/or as otherwise desired.

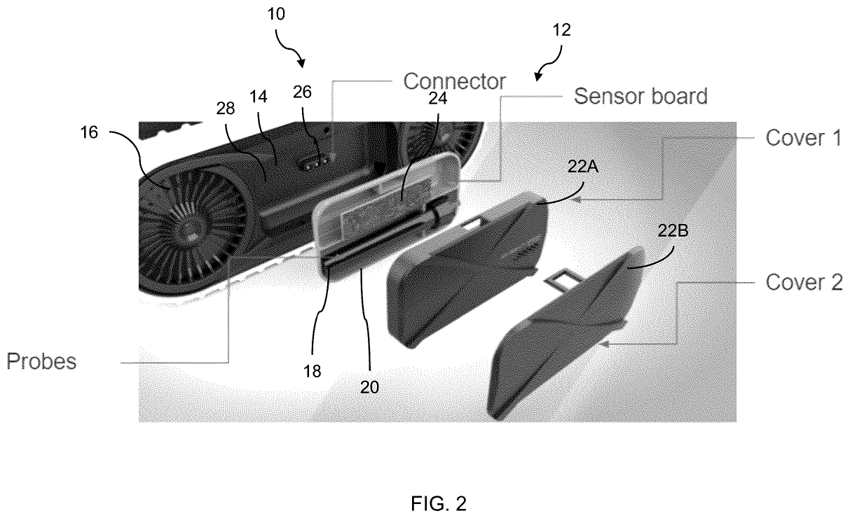

FIG. 2 illustrates another example of the APC 10 with the water sensing system 12. In this embodiment, the water sensing system 12 includes the water sensing probe 18 supported on the APC 10. As illustrated in FIG. 2, the water sensing system 12 may include a housing 20 for supporting the water sensing probe 18 and optionally a sensor board 24 (e.g., a controller for the water sensing system 12) on the APC 10. Optionally, various types of covers such as the cover 22A and/or the cover 22B may be provided to selectively engage the housing 20 and at least partially cover the water sensing probe 18 and the sensor board 24.

In the embodiment of FIG. 2, the APC 10 includes a connector 26 for mechanically and/or electrically connecting the water sensing probe 18 to the APC 10. The connector 26 is illustrated on a lower portion of the body 14 of the APC 10 and defines a recess 28 that at least partially receives the housing 20. However, the connector 26 may be provided at various locations on and/or within the APC 10 as desired, and the particular connector 26 illustrated should not be considered limiting. In other embodiments, other types of connectors may be used to mechanically and/or electrically connect the water sensing probe 18 to the APC 10.

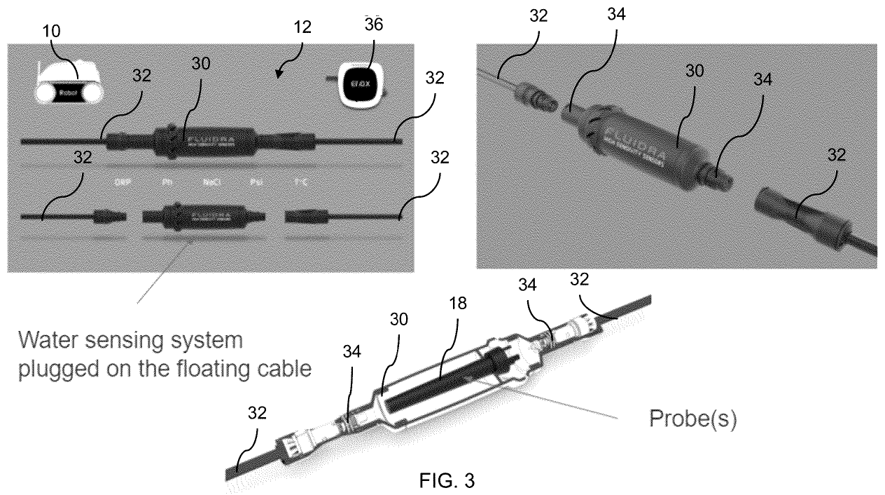

FIG. 3 illustrates another example of the APC 10 with the water sensing system 12. In this embodiment, the water sensing system 12 includes the water sensing probe 18 proximate to but spaced apart from the APC 10. In the embodiment illustrated, the water sensing system 12 includes a housing 30 for supporting the water sensing probe 18 in line with cabling 32 for the APC 10. The cabling 32 may supply electricity to the APC 10 and/or enable a transmission of data to and/or from the APC 10. An end of the cabling 32 may be permanently or removably attached to the APC 10, and an opposing end may be permanently or removably attached to a control box 36 or other device as desired.

The housing 30 optionally may include various connectors 34 such that the housing 30 and probe 18 are detachable from the cabling 32 as desired. The connectors 34 may be various suitable connectors as desired, including but not limited to male/female connectors, threaded connectors, snap-fit connectors, etc. In certain embodiments, the housing 30 with connectors 34 may allow for the water sensing probe 18 to be disconnected from the APC 10 while keeping the water sensing probe 18 connected to the cabling 32 and immersed in water for data collection.

The aforementioned examples of APCs with water sensing systems and water sensing probes are for illustrative purposes only and should not be considered limiting.

Exemplary concepts or combinations of features of the invention may include:
A. An APC for a swimming pool or spa with associated water sensing means.
B. An APC for a swimming pool or spa, the APC comprising a water sensing system.
C. The APC according to any preceding or subsequent statement or combination of statements, wherein the water sensing means are self-powered or powered by the APC.
D. The APC according to any preceding or subsequent statement or combination of statements, wherein the water sensing means are provided natively with the APC or retrofit on an existing APC.
E. The APC according to any preceding or subsequent statement or combination of statements, wherein the water sensing means are onboard the APC.
F. The APC according to any preceding or subsequent statement or combination of statements, wherein the water sensing means are inside the APC or outside the APC.
G. The APC according to any preceding or subsequent statement or combination of statements, wherein the at least one water sensing probe is within a body of the APC.
H. The APC according to any preceding or subsequent statement or combination of statements, wherein the at least one water sensing probe is on an outer surface of a body of the APC.
I. The APC according to any preceding or subsequent statement or combination of statements, wherein the water sensing system comprises at least one water sensing probe proximate to but spaced apart from a body of the APC.
J. The APC according to any preceding or subsequent statement or combination of statements, wherein the water sensing system comprises at least one water sensing probe detachable from the APC.
K. The APC according to any preceding or subsequent statement or combination of statements, wherein the water sensing system is communicatively coupled with at least one of a controller of the APC or a remote device.
L. The APC according to any preceding or subsequent statement or combination of statements, wherein the water sensing means are proximate to a body of the APC.
M. The APC according to any preceding or subsequent statement or combination of statements, wherein the water sensing means are on cabling for the APC, the cabling detachable from the APC.
N. The APC according to any preceding or subsequent statement or combination of statements, wherein the water sensing means comprise one or more of ORP sensors, pH sensors, temperature sensors, conductivity sensors, and/or salinity sensors.
O. A method of managing water of a swimming pool or spa, the method comprising managing the water based on information from a water sensing system on or proximate to an APC.
P. The method according to any preceding or subsequent statement or combination of statements, further comprising controlling a cleaning operation of the APC based on the information from the water sensing system.
Q. The method according to any preceding or subsequent statement or combination of statements, further comprising controlling a piece of pool equipment other than the APC based on the information from the water sensing system.
R. The method according to any preceding or subsequent statement or combination of statements, further comprising generating an alert or notification on a device remote from the APC.
S. An APC for a swimming pool or spa, the APC comprising an onboard water sensing system.
T. An APC for a swimming pool or spa, the APC comprising a water sensing probe proximate to a body of the APC.
U. The APC according to any preceding or subsequent statement or combination of statements, wherein the water sensing probe is on cabling detachable from the APC.
V. A water sensing system for an APC, the water sensing system comprising a water sensing probe configured to be on or proximate to the APC.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with APCs, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. An automatic swimming pool cleaner (APC) for a swimming pool or spa, the APC comprising a water sensing system.

2. The APC of claim 1, wherein the water sensing system comprises at least one water sensing probe onboard the APC.

3. The APC of claim 2, wherein the at least one water sensing probe is within a body of the APC.

4. The APC of claim 2, wherein the at least one water sensing probe is on an outer surface of a body of the APC.

5. The APC of claim 1, wherein the water sensing system comprises at least one water sensing probe proximate to but spaced apart from a body of the APC.

6. The APC of claim 1, wherein the water sensing system comprises at least one water sensing probe detachable from the APC.

7. The APC of claim 1, wherein the water sensing system comprises at least one water sensing probe on cabling for the APC.

8. The APC of claim 1, wherein the water sensing system is communicatively coupled with at least one of a controller of the APC or a remote device.

9. The APC of claim 1, wherein the water sensing system comprises at least one of an ORP sensor, a pH sensor, a temperature sensor, a conductivity sensor, and/or a salinity sensor.

10. A water sensing system for an automatic swimming pool cleaner (APC), the water sensing system comprising a water sensing probe configured to be on or proximate to the APC.

11. The water sensing system of claim 10, wherein the water sensing probe is onboard the APC.

13. The water sensing system of claim 11, wherein the water sensing probe is inside the APC or outside the APC.

14. The water sensing system of claim 10, wherein the water sensing probe is proximate to a body of the APC.

15. The water sensing system of claim 10, wherein the water sensing probe is on cabling for the APC, and wherein the cabling is detachable from the APC.

16. The water sensing system of claim 10, wherein the water sensing probe includes one or more of ORP sensors, pH sensors, temperature sensors, conductivity sensors, and/or salinity sensors.

17. A method of managing water of a swimming pool or spa, the method comprising managing the water based on information from a water sensing system on or proximate to an automatic swimming pool cleaner (APC).

18. The method of claim 17, further comprising controlling a cleaning operation of the APC based on the information from the water sensing system.

19. The method of claim 17, further comprising controlling a piece of pool equipment other than the APC based on the information from the water sensing system.

20. The method of claim 17, further comprising generating an alert or notification on a device remote from the APC.
